(19) United States
(12) Patent Application Publication
(10) Pub. No.: US 2007/0289538 A1
(43) Pub. Date: Dec. 20, 2007

(54) Livestock Feeder

(76) Inventors: Jefford Grant Sherriff, Yeppoon (AU); Leonie Gwendoline Sherriff, Yeppoon (AU)

Correspondence Address: SHOEMAKER AND MATTARE, LTD, 10 POST OFFICE ROAD - SUITE 110, SILVER SPRING, MD, 20910, US

(21) Appl. No.: 11/422,433

(22) Filed: Jun. 6, 2006

(51) Int. Cl. A01K 5/01

(52) U.S. Cl. 119/53

(57) ABSTRACT

The present invention is directed to a livestock feeder where feed in a hopper is diverted to a substantially flat surface through an adjustable opening. Livestock can access the feed on the substantially flat surface by pushing open a feed gate which returns to its initial position after the opening force has been removed. The feed gate prevents contamination of the feed by rain and prevents birds from entering the hopper and eating the feed.

### FIELD OF INVENTION

The present invention relates to livestock feeders. The present invention relates particularly to gravity-fed self-feeders. Reference to livestock in the specification comprises cattle, horses, sheep, goats and other domesticated animals and particular reference to cattle is by way of example only.

### BACKGROUND OF THE INVENTION

Gravity-fed livestock feeders generally have a hopper in which feed is stored, an opening in the hopper from which feed is dispensed and a trough below the opening where feed falls under the influence of gravity for consumption by livestock. The type of feed used in these hoppers comprises pelleted food, grain and grain mixtures. Many of the gravity-fed livestock feeders have adjustable gates which controls the amount of feed dispensed. By way of example, the feeder disclosed in U.S. Pat. No. 5,036,798 has a slidable gate which can be remotely adjusted to increase or decrease the height of the opening and hence the amount of feed dispensed.

There are however a number of disadvantages associated with these feeders. Where there has been rain or there is a high percentage of moisture in the air or livestock have been licking the gate or areas adjacent the gate, the feed absorbs the moisture and the wet feed forms a congealed mass that blocks the opening and prevents further feed from being dispensed. If the gates are opened further to overcome the blockage problem, more feed is discharged and possibly wasted.

Where the opening is narrow such as with the self-regulated feeding of young cattle to grow them rather than fatten them, these blockages occur frequently as the young cattle try to lick out the feed. As a consequence the openings require manually cleaning every 2 to 3 days. Since these feeders are often placed in paddocks to feed and fatten livestock, the frequent cleaning of these feeders is very laborious and time consuming.

As well, birds often eat the excess feed in the trough and even have access to the stored feed if the opening is large enough.

### SUMMARY OF THE INVENTION

It is an object of the present invention to provide an alternative feeder that overcomes at least in part one or more of the abovementioned disadvantages.

In one aspect the present invention broadly resides in a livestock feeder comprising a hopper housing for storage of feed; a diverter comprising an inclined surface and a substantially flat surface wherein the inclined surface is adapted to divert feed to the substantially flat surface; and a feed guide for controlling the amount of feed passing to the substantially flat surface, said feed guide is positioned relative to the inclined surface to form an opening through which feed can pass to the substantially flat surface.

In another aspect the present invention broadly resides in a livestock feeder comprising hopper housing for storage of feed; a diverter comprising an inclined surface and a substantially flat surface wherein the inclined surface is adapted to divert feed to the substantially flat surface; a feed guide for controlling the amount of feed passing to the substantially flat surface, said feed guide is positioned relative to the inclined surface to form an opening through which feed can pass to the substantially flat surface; a pivotally mounted feed gate that provides access to the feed collected on the substantially flat surface, wherein the feed gate is positioned on the outer side of the feed guide and distal from the inclined surface.

The feed gate preferably forms part of the outer wall of the feeder. Preferably the feed gate in the closed position is substantially in-line with the feeder outer wall.

The feed gate in the closed position is preferably adjacent the outer end of the substantially flat surface. The feed gate in the closed position is preferably positioned to substantially prevent rain from contaminating the feed and birds eating the feed.

The feed gate is preferably hinged. The feed gate is preferably hinged so that it can be opened inwards and outwards. When livestock is feeding, the feed gate is preferably hinged to open inwards and return under gravity to its initial position because of the weight of the gate. When adjusting the length of the feed guide and while training livestock to feed from the feeder, the feed gate is preferably opened outwards and preferably held in the raised outward position. In an alternate form, the gate is spring biased so that it returns to the closed position after opening.

The feed gate may be limited in its range of movements to restrict or prevent access to the substantially flat surface. The feed gate may be limited in its range of movements by the placement of one or more pegs adjacent the feed guide. In one preferred form, the feed gate is fixed in a closed position and the livestock use their tongue to pass in the gap formed by the gate and the substantially flat surface to flick feed outwardly and into the trough.

The outer end of the substantially flat surface preferably forms a ledge on which livestock can access the collected feed.

The feed guide is preferably adjustable so that the amount of feed can be regulated. The feed guide is preferably adjustable with a sliding plate extendable from the end opposing the inclined surface. Alternatively the feed guide is adjustable by means of its mounting which may allow adjustment of the feed guide position.

The inclined surface and the substantially flat surface preferably form a one piece member. The inclined surface and the substantially flat surface preferably form a one piece base member.

Preferably the substantially flat surface and fed gate are preferably elongate and extend longitudinally.

Preferably there are two feed gates either side of the feeder.

Preferably the diverter comprises a substantially A-shaped member positioned within the hopper housing.

The feeder preferably comprises one or more troughs positioned below the substantially flat surface or ledge to collect fallen feed. Preferably there are water discharge holes part-way up the trough for the discharge of collected rainwater.

### BRIEF DESCRIPTION OF THE DRAWINGS

In order that the present invention can be more readily understood and put into practical effect, reference will now be made to the accompanying drawings wherein:

FIG. 1 is a diagrammatic perspective view of the feeder of the preferred embodiment;

FIG. 2 is a diagrammatic transverse sectional view of the feeder;

FIG. 3 is a diagrammatic sectional view of the feed gate in an open position;

FIG. 4 is a diagrammatic sectional view of the feed gate in a closed position, and

FIG. 5 is a diagrammatic view of the feed guide.

### DETAILED DESCRIPTION OF THE PREFERRED EMBODIMENT

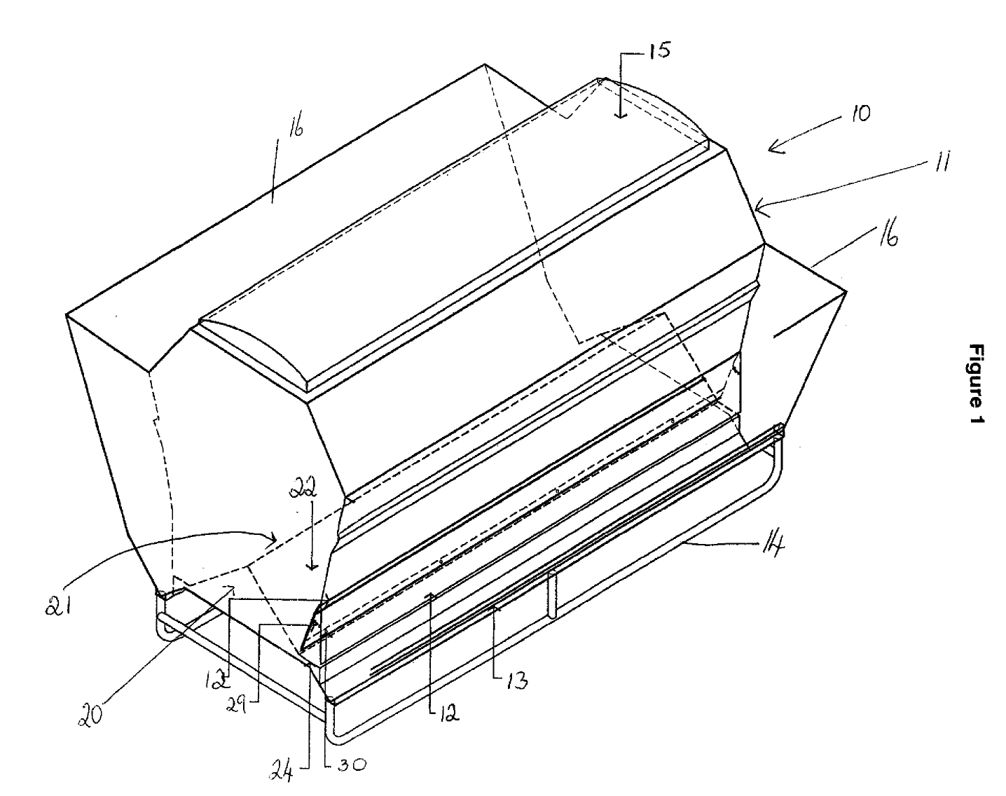

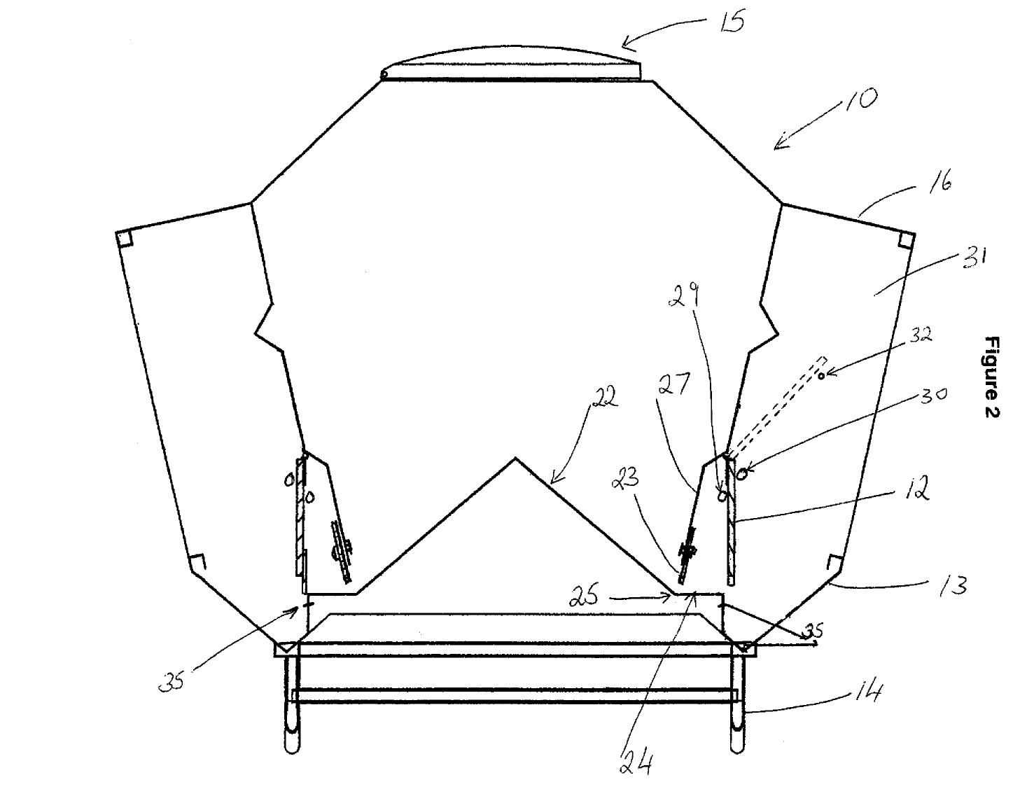

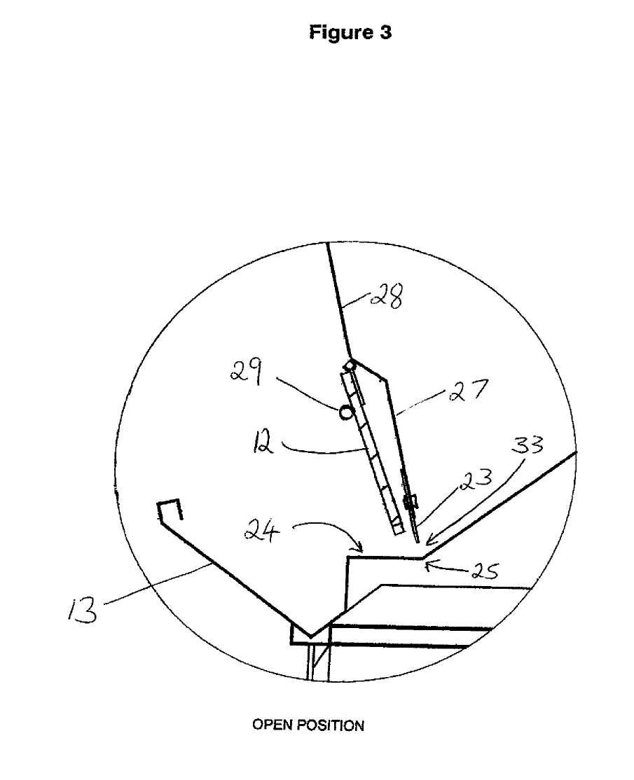

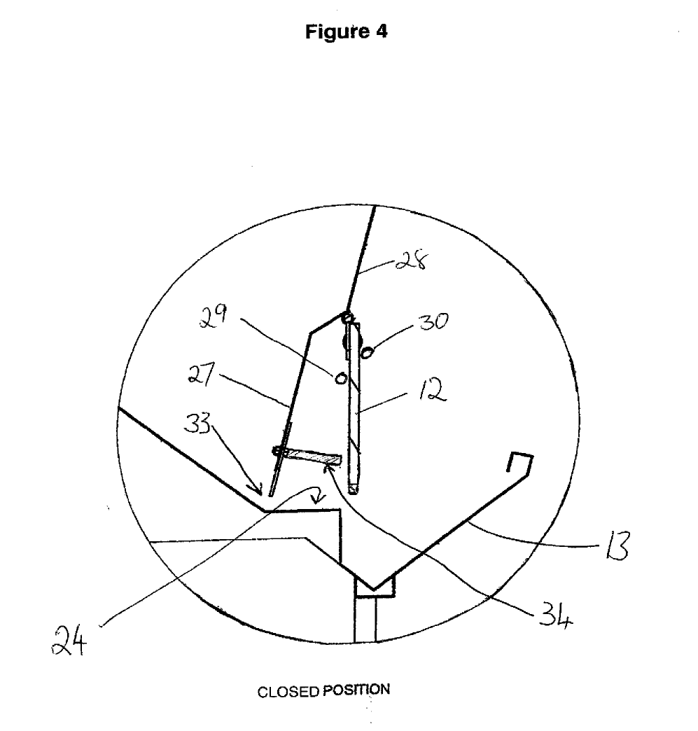

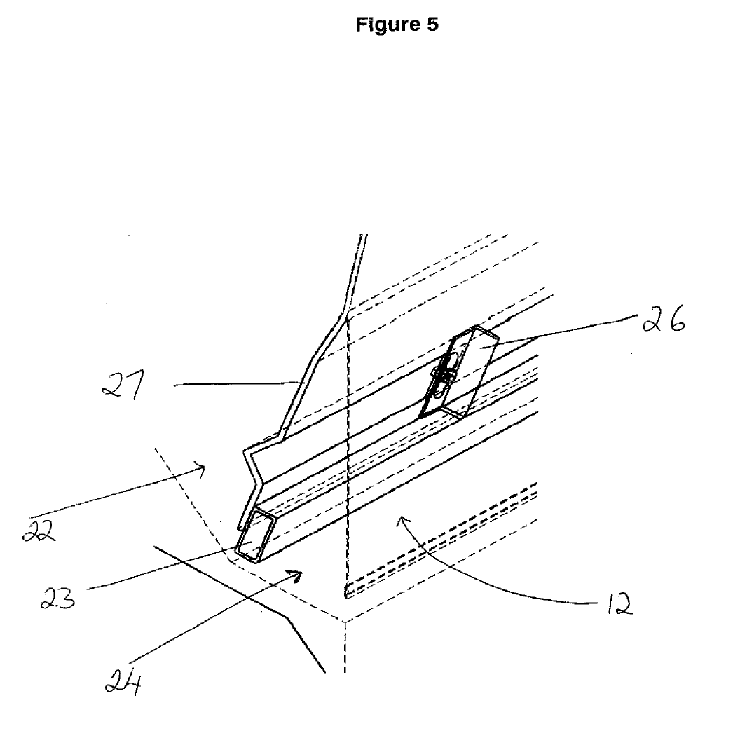

With reference to FIGS. 1 to 5, there is shown a livestock feeder 10 which has a hopper portion 11, feed gate 12, trough 13 supported on a base frame 14.

The hopper portion 11 has a lid 15 through which feed is passed into the hopper portion 11. The hopper portion 11 also has an awning portion 16 on each side of the feeder 10. The awning portion 16 provides the feed gate 12 and trough 13 protection against the weather. The hopper portion 11 has a triangular floor 20 wherein the apex 21 of the triangular floor 20 extends along a substantially central and longitudinal axis of the feeder 10. The inclined surfaces 22 on either side of the apex 21 extend downwardly away from the apex 21. Each inclined surface 22 adjoins a substantially flat surface 24 before reaching the feed gate 12. Where the inclined surface 22 adjoins a substantially flat surface 24, a longitudinally extending abutment edge 25 is formed. The substantially flat surface 24 extends from the abutment edge 25 to the edge of the trough 13. The inclined surfaces 22 and substantially flat surfaces 24 form a one-piece triangular floor 20.

There is a feed guide 27 that extends from an outer hopper wall 28 of the hopper portion 11 to a position substantially opposing the abutment edge 25. The length of the feed guide 27 is adjustable by means of an overlying slidable plate 23. The overlying slidable plate 23 is fixed in position by a sliding bracket 26. The length of the feed guide 27 determines the size of the opening 33 between the end of the feed guide 27 and the abutment edge 25. The larger the opening 33, greater is the amount of the feed able to pass through the opening 33 to the substantially flat surface (or ledge) 24. In this way, the amount of feed passing to the substantially flat surface 24 and consequently to the livestock, can be controlled.

The feed guide 27 is adjustable as described above by providing a sliding plate 23 that can be raised and lowered to form a large or small opening 33 respectively. The use of the sliding plate allows the feeder to be cleaned by running a flat edged tool the length of the ledge 24 without interference.

The feed gate 12 is hinged to the outer hopper wall 28 so that when the feed gate 12 is pushed inwards it returns to its initial position after the pushing force is no longer applied. The feed gate 12 has an initial position being a closed position. To open the feed gate 12, livestock must push the feed gate 12 inwards. In the closed position, the feed gate 12 is substantially inline with the outer hopper wall 28. In the closed position, the feed gate 12 is adjacent the outer edge of the substantially flat surface 24. In the closed position, the feed gate 12 prevents rain and adverse weather from reaching the substantially flat surface 24 and contaminating the feed. In the closed position, the feed gate 12 prevents birds from entering the hopper to eat the feed.

The feed gate 12 may be restricted in its range of movement by one or more pins 29, 30 locatable in the end wall 31 of the hopper portion 11. The feed gate 12 may be held open at an inward position by pin 29 so that livestock can be trained to eat feed off the substantially flat surface 24. The feed gate 12 may be prevented from opening outwards by pin 30 inserted in the end wall 31 adjacent the outside of feed gate 12. The feed gate 12 when in the closed position may be prevented from opening inwardly by the positioning of pin 29 in the hopper wall. In order to gain access to adjust the length of the feed guide 27 or to train livestock to feed from the feeder 10, the feed gate 12 may be opened outwardly and raised. The outwardly raised position of the feed gate 12 may be maintained by the placement of retaining peg 32.

In one preferred embodiment there is a removable spacer 34 fastened to the feed guide 27 to prevent wild pigs and the like from pushing the feed gate 12 inwards and consuming the feed. With the spacer 34 in position, cattle can still feed from under the feed gate 12 as they have comparatively longer tongues than the wild pigs.

Where the feed gate 12 is twelve feet or longer and there are pins 29 at each end, the middle section of the feed gate 12 may be bent inward with the eager feeding by the cattle. One or more spacers 34 prevents the bending of the feed gate 12.

The trough 13 is shaped to allow livestock to eat the feed that has fallen into the trough 13. Drainage holes 35 for the discharge of collected water are positioned part way up the sides of the trough 13. The position of the drainage holes 35 allows for the efficient drainage of the collected water and avoids the problems of blockage by water contaminated feed.

The base frame 14 provides a stable base and lifts the hopper portion 11, feed gate 12 and trough 13 to a suitable height for the livestock to access the feed.

Feed is placed into the hopper portion 11 and diverted to the substantially flat surfaces 24 by the respective inclined surfaces 22. The amount of feed reaching the substantially flat surface 24 is controlled by the size of the opening 33 formed with the feed guide 27. Livestock can access the feed on the substantially flat surface 24 by pushing the feed gate 12 inwards. Because there is effort required to open the feed gate 12, livestock will also eat feed that has fallen into the trough 13.

The advantage of the feeder is that substantially all the accessed feed is consumed and there is little if any feed lying in the trough.

It will of course be realized that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

What is claimed is:

1. A livestock feeder comprising
hopper housing for storage of feed;
a diverter comprising an inclined surface and a substantially flat surface wherein the inclined surface is adapted to divert feed to the substantially flat surface;
a feed guide for controlling the amount of feed passing to the substantially flat surface, said feed guide is positioned relative to the inclined surface to form an opening through which feed can pass to the substantially flat surface;
a pivotally mounted feed gate that provides access to the feed collected on the substantially flat surface, wherein the feed gate is positioned on the outer side of the feed guide and distal from the inclined surface.

2. A feeder as claimed in claim 1, wherein the feed gate in the closed position is adjacent the outer end of the substantially flat surface and forms part of the outer wall of the feeder.

3. A feeder as claimed in claim 1, wherein the feed gate is hinged to open inwards and return under gravity to the closed position after opening.

4. A feeder as claimed in claim 1, wherein the feed gate is hinged to open inwards and return under gravity to the closed position after opening, wherein the range of movement of the feed gate is limited in its range by the placement of one or more pegs adjacent the feed guide thereby restricting or preventing access to the substantially flat surface.

5. A feeder as claimed in claim 1, wherein the feed guide is adjustable with a sliding plate extendable from the end opposing the inclined surface so that the amount of feed can be regulated.

6. A feeder as claimed in claim 1, wherein the inclined surface and the substantially flat surface form a one piece base member, the substantially flat surface and feed gate are elongate and extend longitudinally.

7. A feeder as claimed in claim 1, wherein the diverter comprises a substantially A-shaped member positioned within the hopper housing.

8. A feeder as claimed in claim 1, wherein there are two feed gates on either side of the feeder and the diverter comprises a substantially A-shaped member positioned within the hopper housing.

9. A feeder as claimed in claim 1, wherein the feeder comprises one or more troughs positioned below the substantially flat surface or ledge to collect fallen feed.

10. A feeder as claimed claim 1, wherein the feeder comprises one or more troughs positioned below the substantially flat surface or ledge to collect fallen feed, said troughs have one or more water discharge holes part-way up the trough for the discharge of collected rainwater.

11. A feeder as claimed claim 1, wherein the feed gate is hinged to open inwards and return under gravity to the closed position after opening, wherein the range of movement of the feed gate is limited in its range by the placement of one or more pegs adjacent the feed guide thereby restricting or preventing access to the substantially flat surface, the feed guide is adjustable with a sliding plate extendable from the end opposing the inclined surface so that the amount of feed can be regulated, and the inclined surface and the substantially flat surface form a one piece base member, the substantially flat surface and feed gate are elongate and extend longitudinally.

12. A feeder as claimed claim 1, wherein the diverter comprises a substantially A-shaped member positioned within the hopper housing, there are two feed gates on either side of the feeder and the diverter comprises a substantially A-shaped member positioned within the hopper housing, and the feeder comprises one or more troughs positioned below the substantially flat surface or ledge to collect fallen feed, said troughs have one or more water discharge holes part-way up the trough for the discharge of collected rainwater.

13. A feeder as claimed claim 1, wherein the feed gate is hinged to open inwards and return under gravity to the closed position after opening, wherein the range of movement of the feed gate is limited in its range by the placement of one or more pegs adjacent the feed guide thereby restricting or preventing access to the substantially flat surface, the feed guide is adjustable with a sliding plate extendable from the end opposing the inclined surface so that the amount of feed can be regulated, the inclined surface and the substantially flat surface form a one piece base member, the substantially flat surface and feed gate are elongate and extend longitudinally, the diverter comprises a substantially A-shaped member positioned within the hopper housing, there are two feed gates on either side of the feeder and the diverter comprises a substantially A-shaped member positioned within the hopper housing, and the feeder comprises one or more troughs positioned below the substantially flat surface or ledge to collect fallen feed, said troughs have one or more water discharge holes part-way up the trough for the discharge of collected rainwater.
